(19) United States
(12) Patent Application Publication
(10) Pub. No.: US 2010/0309125 A1
(43) Pub. Date: Dec. 9, 2010

(54) Button To Change Modes of a Pointing Device

(76) Inventors: Charles A. Sellers, Houston, TX (US); Earl W. Moore, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/480,334

(22) Filed: Jun. 8, 2009

(51) Int. Cl. G06F 3/033

(52) U.S. Cl. 345/161

(57) ABSTRACT

A system includes a pointing device with a first and a second mode. The system also includes a pointing device button to generate a primary action and to generate a change mode action. The change mode action is to change the pointing device to a second mode if the pointing device is in the first mode for moving a pointer.

### BACKGROUND

Computers with graphical user interfaces use pointing devices to navigate and activate items on the display. Pointing devices move a pointer on a display to allow a user to control the graphical user interface. A mouse is an example of a pointing device. Moving a mouse on a surface controls a cursor on a display. A touch-pad is a surface that senses the movement of a object, for example a user's finger, that is in contact with the surface. The movement of the object is translated into movement of the cursor on a display. A pointing stick is a pointing device that translates force applied to the pointing stick into the movement of a cursor on a display.

### BRIEF DESCRIPTION OF THE DRAWINGS

Some embodiments of the invention are described with respect to the following figures:

FIG. 1 is a pointing device according to an embodiment of the invention;

FIG. 2 is a system according to an embodiment of the invention;

FIG. 3 is a block diagram of an exemplary system in which an embodiment of the invention is provided;

FIG. 4 is a block diagram of an exemplary system in which an embodiment of the invention is provided; and

FIG. 5 is a flow diagram according to an embodiment of the invention.

### DETAILED DESCRIPTION

The embodiments of the invention are for a pointing device that has multiple modes of operation that can be changed using the pointing device buttons. Some pointing devices may include buttons or wheels for performing operations that the pointing device can perform. For example, a pointing device may have a scroll wheel that can be used for scrolling data in a document.

If a pointing device can operate in a pointing mode where a pointer is moved on a display and in alternative modes then the additional hardware such as the wheel and additional buttons used for scrolling can be removed from the design of the pointing device to reduce the number of parts in the computer. To change the mode of the pointing device, the pointing device button can be activated in an alternative way that generates a change mode action.

In an embodiment, the pointing device is a pointing stick that includes a pointing device button that can be used for a button activation. A button activation may be known as a mouse click but is not limited to a mouse click. The pointing device button can activate primary action with a button activation according to the location of a pointer on the display. The primary actions can include, for example selecting or deselecting an item or activating a program or program feature. The primary actions, may be referred to as a right click or a left click in some embodiments. The pointing device button can also activate secondary functions. A secondary function activated by the pointing device button can be a change mode function. The change mode action can change the operation of the pointing device from a first mode to a second mode. For example, a pointing device may be operating in a pointing mode to move a pointer on a display and the change mode action can change the operating mode of the pointing device to a scroll mode.

Changing the operating mode of the pointing device to an alternative operating mode can be by activating the pointing device button for a period of time longer than the time to activate the primary action, in one embodiment. After the pointing device button is released the operation of the pointing device is in an alternative mode and the pointing device button does not have to be continuously activated to remain in that mode.

In an alternative embodiment, changing the operating mode of the pointing device to an alternative operating mode can be by activating a pointing device button and a second pointing device button. After the pointing device button and the second pointing device buttons are released the operation of the pointing device is in an alternative mode and the pointing device button and the second pointing device button do not have to be continuously activated to remain in that mode.

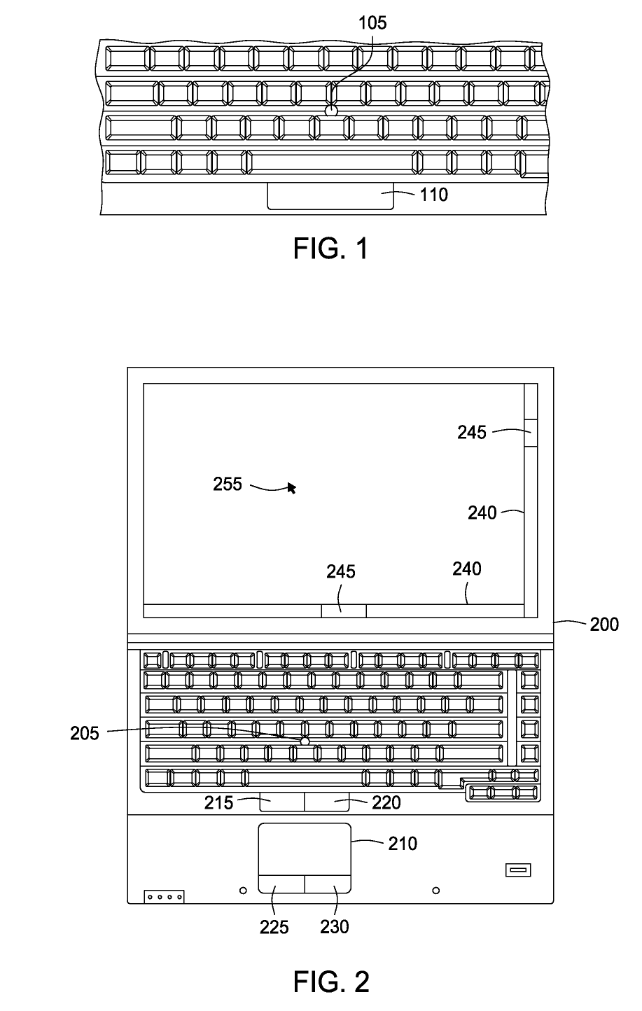

With reference to the figures, FIG. 1 is a pointing device according to an embodiment of the invention. The pointing device in the embodiment of FIG. 1 is a pointing stick 105. In one embodiment the pointing stick 105 is located between keys of a keyboard, but the pointing stick may be coupled anywhere on the computer or in a peripheral connected to computer by a wire or wirelessly.

If force is applied to the pointing stick 105 the pointer on the display is moved in the direction of the force. For example, if the force applied moves the pointing stick to move to the right the pointer will move on the display to the right. The force applied to the pointing stick may cause other actions to occur if the pointing stick is in an alternative operating mode. If the pointing stick is in the scroll mode, data on the display can be scrolled in a vertical or horizontal direction.

The pointing device has a button 110 for generating button activations. A button activation may result in a different actions being performed, for example, a primary action may select or deselect an item or activate a program or program feature. To generate a button activation the button 110 may be activated by a user for a period of time. An example of the period of time that may be used to generate a primary action is the activation of the button by a user for less than 1 second, but other times may be pre-programmed or the time may be user adjustable.

The button 110 can have additional functions that are activated by activating the button for an extended period of time. For example the extended period of time may be at least 1 second. If the button is activated for the extended period of time and released the button can create a change mode action. In some embodiments, the change mode action can change the pointing device 105 from a pointing mode to a scroll mode. If the pointing device is in the scroll mode the button may be activated for an extended period of time and the change mode action may change the operation of the pointing device to a pointing mode, in some embodiments.

In some embodiments, if the mode is changed to the scroll mode the pointing device remains in the scroll mode without activating button continuously to generate the change mode signal for allowing the pointing device to move the data on the display without continuously activating the button while the pointing device is scrolling data on the display.

FIG. 2, is a system according to an embodiment of the invention. The system 200 may be a laptop computer, in one embodiment. The system 200 includes a pointing device 205 with pointing device buttons 215 and 220. The system also includes a pointing device 210 with pointing device buttons 225 and 230. In some embodiments, to change the mode of the pointing device is by activating both of the pointing device buttons for a pointing device, for example pointing device buttons 215 and 220 or 225 and 230. In the alternative mode a button activation may not be assigned an activity if the primary actions are not available when the pointing device is not in the pointing mode and generating a change mode action to change the pointing device from an alternative mode to a pointing mode may be by activating a button for less than the extended period of time.

In the embodiment of FIG. 2, pointing device 205 is a pointing stick and pointing device 210 is a touch pad. In alternative embodiments, the pointing device may be a pointing stick, a touch pad, a mouse, a track ball, a pen input device, a touch display, joy stick or any other device that may be used for moving the pointer on a computer display. In some embodiments, the pointing device may be connected to the computer by a wire or wirelessly.

The pointing device button may be a mechanical button or a touch sensor connected to a controller. Examples of touch sensors are a capacitive touch pad and resistive touch pads but other touch responsive devices may be used.

In one embodiment, the alternative mode is a scroll mode. The scroll mode may be used if a document is larger than the viewable area of the display. For example a text document may contain multiple pages of text. If all the pages of the document were on the display the text on the pages may be too small to read however if the text is readable on the display all the pages may not be viewable. If a user desired to scroll to a different portion of the document the user may change the mode of the pointing device to a scroll mode. If the pointing device is in the scroll mode the document may be moved in the direction of movement of the pointing device, for example if the pointing device was moved the document pages move up to show previously unviewable text. Other types of data may also be used in a scroll mode, for example, a spread sheet, a webpage or an image may be used in a scroll mode to view data that may not be on the display. In some documents the boundaries of the document may be identified by a scroll box 245 in scroll bars 240 on the display. If the pointing device is in the scroll mode the scroll box 245 may move the up and down or left and right within the area designated by the scroll bar 240 to indicate that the document is being scrolled by the pointing device.

The pointing devices 205 and 210 can have the same mode or different modes. If the pointing devices are in the same mode, for example, the pointing mode the pointing devices may move the pointer 255 in a direction on a display. In an alternative embodiment the pointing devices may be in different modes, for example, if the pointing device 205 is in a pointing mode the pointing device may move the pointer 255 on the display 250 and if the pointing device 210 is in a scroll mode the data on the display 250 may be moved in a vertical or horizontal direction. In some embodiments, the pointing device buttons of one pointing device may change the mode of that pointing device and of another pointing device connected to the computer.

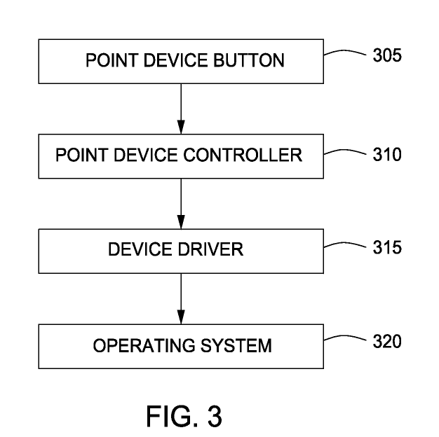

FIG. 3 is a block diagram of an exemplary system in which an embodiment of the invention is provided. The flow diagram includes a pointing device button 305. The pointing device button can send a signal to the pointing device controller 310. A controller is relied on by other devices for access to a computer subsystem. In one embodiment, the pointing device button 305 relies on the pointing device controller 310 for communicating with the computer. The pointing device controller can be an ASIC (application specific integrated circuit) for receiving signals from the pointing device or the pointing device button. In some embodiments, the pointing device button may communicate with one controller and another controller communicates with the pointing device.

The pointing device controller 310 can communicate with the device driver 315. The device driver 315 is a software component that permits a computer system to communicate with a device. In some embodiments, the device driver can manipulate the hardware in order to transmit data to the device. In alternative embodiments, the device driver performs data translation for allowing data from devices to be transformed into data understandable by the operating system.

In some embodiments, the device driver includes a graphical user interface for changing settings of the pointing devices. If there is more than one pointing device attached to a computer the pointing devices may have settings that allow the pointing devices to be setup independently. The graphical user interface may allow the user to change the action that the computer takes if the device driver receives from the pointing device button 305 a signal via the pointing device controller 310 to change modes. For example, a change mode instruction can place a computer in a presentation mode, a multimedia mode, or an audio control mode but the embodiments are not limited to these modes. In a presentation mode the pointing device may control functions such as displaying a next slide or a previous slide if the pointing device is activated in a left or right direction. In a multimedia mode the pointing device may control functions such as play, stop, rewind, and fast forward if the pointing device is activated. In an audio control mode the pointing device may control the volume of the audio output from a computer if the pointing device is activated up or down.

The device driver 315 communicates with the operating system 320, informing the operating system 320 of the current mode. The operating system 320 can communicate with other device drivers such as the device driver for the display to change the indicators on the display to indicate the current mode. For example, in the pointing mode the operating system may display a pointer on the display and in the scroll mode the operating system may not display the pointer.

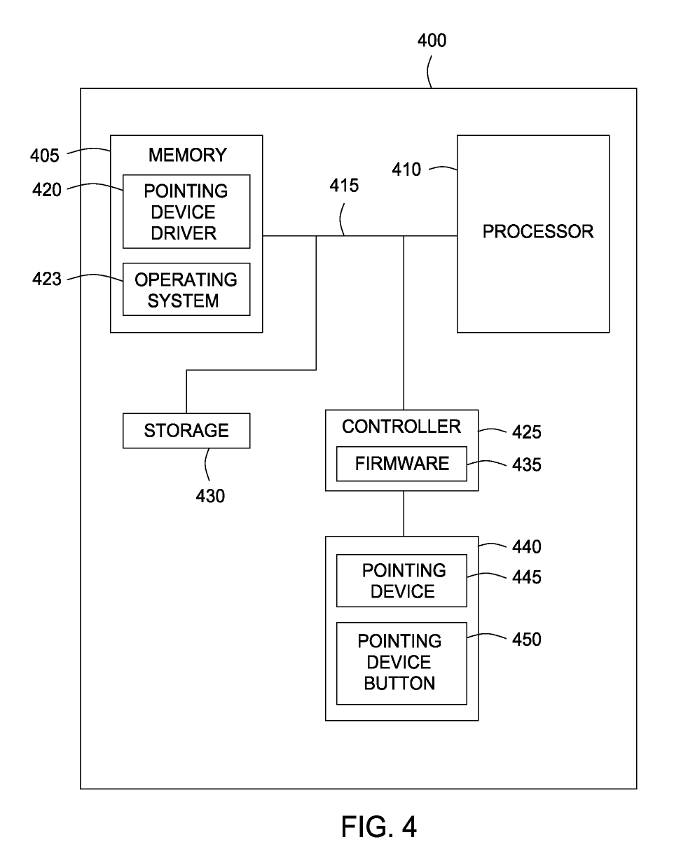

FIG. 4 is a block diagram of an exemplary system in which an embodiment of the invention is provided. The computer 400 includes a pointing device system 440. The pointing device system 440 includes a pointing device 445 and a pointing device button 450. The pointing device system 440 is connected to a controller 425. The controller 425 may include the firmware 435. The firmware 435 is software stored in a ROM (read only memory) that upon startup of the controller may tell the controller how to operate. The firmware may include startup routines and low level input output for the controller. In some embodiments, the ROM can be a rewritable, such as flash memory or an EEPROM (electronically erasable programmable read only memory). The use of rewritable memory for the firmware can allow the firmware to be updated with new features or to correct problems. In some embodiments, the firmware can be updated to include instructions that a change mode signal from the pointing device system 440 may change the pointing device 445 from a pointing mode to an alternative mode.

The firmware can be updated by downloading the replacement firmware to a computer and installing the firmware on the ROM. In another embodiment, the firmware is stored on a portable storage that is read by the computer and installed on the ROM for the controller 425.

If the controller 425 generates the signal to change mode a bus 415 communicates the signal to the pointing device driver 420 that is in the memory 425. In an alternative embodiment, the controller can generate a signal to the device driver 420 that pointing device button was activated for an extended period of time. The pointing device driver 420 can receive the signal from the controller and translate the signal into a change mode action. The device driver 420 communicate the change mode action to the operating system 423 located in the memory 405.

The controller may communicate with a device driver. The device driver also communicates with the operating system and may be supplied with the operating system or with the pointing device. In some embodiments, the pointing device driver 420 can be updated. The updates to the pointing device driver may include the instructions that cause the pointing device mode to change. The pointing device mode can change in response to an action of the pointing device button communicated to the device driver through the controller 425. The updated device driver with the instructions for the pointing device may be stored on a portable storage.

The processor 410 may receive interrupts generated by the controller 425. An interrupt can be a signal from the controller 425 requesting attention from the processor 410. The processor can suspend the current operations and transfer control to the interrupt handler. The interrupts cause the processor 410 to process the signal from the controller 425 to manipulate the image being displayed or control a program. The manipulation of the image on the display can be the movement of a pointer in a pointing mode, the movement of data vertically or horizontally into a scroll mode. The communications bus 415 may communicate with the controller for the storage 430. The storage 430 can store the operating system 423 and the pointing device driver 420 prior to being on the memory, in some embodiments.

The communications bus 415 may communicate with other controllers for example a controller for the display. The controller for the display may send signals to the display that result in a change to the display if pointing device changes to an alternative mode from the pointing mode, for example a scroll mode.

In some embodiments the interface for the device driver for a pointing device will allow the user to select different actions that are completed upon activation of a pointing device button. The interface may allow a selecting of the modes that the pointing device operates in when the pointing device button enables a change mode. The action can be for controlling programs for example a scroll mode controls the displaying of data on the display. The embodiments of the invention are not limited to scroll mode and a pointing mode. Other modes, for example, that can be assigned to a pointing device are a volume control mode, a media player control mode or a presentation mode.

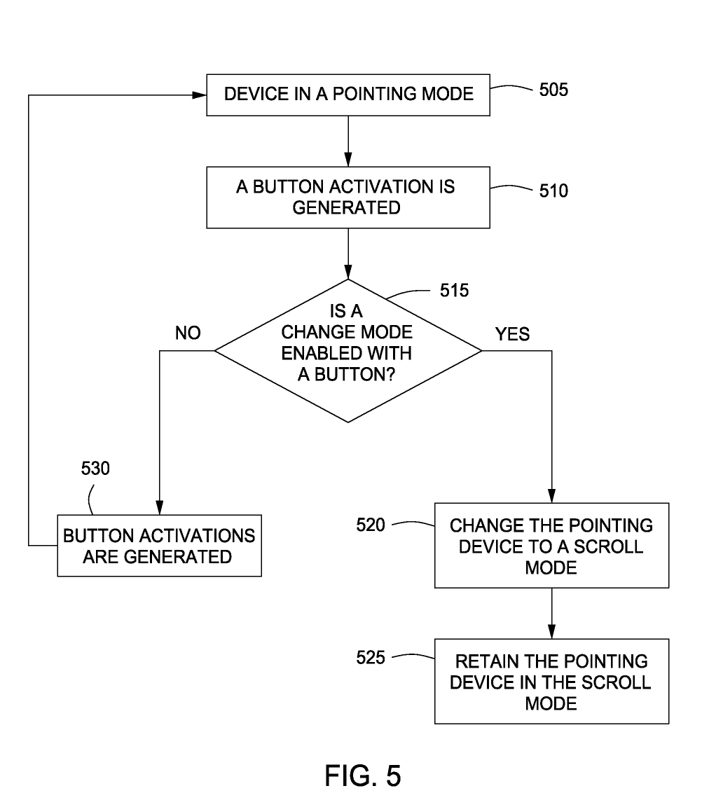

FIG. 5 depicts a flow chart of a method according to an embodiment of the invention. The method begins with the device in a pointing mode (at 505). In the pointing mode the user of pointing device can control movements of the cursor on the display of the computer. If the pointing device is in a pointing mode a button activation can be generated (at 510). The button activation can generate a primary action to open programs, open menus or perform other functions. For example, if the pointer of the pointing device is pointing at an icon representing a program the button activation may open the program. Another example of a primary action is opening a menu on a toolbar to reveal the items on the menu or selecting or deselecting an item. The activation of the button can be received by the controller 425 to determine if a change mode was enabled by the button (at 515).

In one embodiment, if the controller receives a signal generated from a pointing device button the controller can determine if a second pointing device button is activated. If the pointing device button is activated and the second pointing device button is activated the controller can generate a change mode signal to the device driver.

In another embodiment, the controller includes firmware that enables the controller to interpret the activation of a button for less than a programmed amount of time to be a primary action and the activation of the button for at least the programmed amount of time to be change mode action. For example the programmed amount of time may be 1 second although the amount of time may be other lengths. If a change mode was not enabled and the pointing device button is activated a primary action is generated (at 530) by the controller.

The pointing device can remain in the pointing mode (at 505) if the change mode action is not enabled with a pointing device button. In the pointing mode the pointing device can move the pointer on the display.

The controller 425 can interpret the button activation (at 510) to determine if a change mode is enabled with the button (at 515). If the change mode is enabled with the button (at 515) the pointing device mode is changed to a scroll mode (at 520) in one embodiment.

The pointing device is retained in the scroll mode (at 525). In some embodiments, the pointing devices are not located where a user can apply force to the pointing device and activate the pointing device buttons with one hand, for example, a pointing stick may be positioned between keys of a keyboard and the pointing stick button may be next to the keyboard such as by the space bar. In one embodiment, a user can use one hand to place the pointing device in the alternative mode or the pointing mode and then use the pointing device in the current mode if the pointing device is retained in the current mode without a user continuing to activate the pointing device button.

In some embodiments, the scroll mode is retained until a change mode action is received by the controller and the pointing device can return to the pointing mode. In an alternative embodiment there may exist a third mode that is enabled prior to returning to the pointing mode. For example, the first change mode action may change the pointing device from the pointing mode to the scroll mode and the second change mode action may change the pointing device to another mode. If there are two modes, the pointing mode and the scroll mode, the pointing device may return to the pointing mode from the scroll mode if other actions are taken. For example, since a pointer may not be used in the scroll mode a button activation would not have a function to perform, such as activating a program. If there are two modes a primary action may return the pointing device to a pointing mode from the alternative mode such as a scroll mode without the pointing device button generating a change mode action. In another embodiment, the pointing device may return to a pointing mode after a period of inactivity in an alternative mode. For example if the pointing device is in a scroll mode and the pointing device is not operated for a programmed period of time the pointing device may return to the pointing mode.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computing system comprising:
a pointing device with a first mode and a second mode; and
a button to generate a primary action and to generate a change action, wherein the change mode action is to change the pointing device to the second mode if the pointing device is in the first mode.

2. The device of claim 1 further comprising a second button.

3. The device of claim 2 wherein the change mode action is activated by the button and the second button.

4. The device of claim 1 wherein the change mode action is generated if the button is activated for a time that is longer than a programmed time.

5. The device of claim 1 further comprising a second pointing device wherein if the pointing device is in the first mode the second pointing device is in the second mode and if the pointing device is in the second mode the second pointing device is in the first mode.

6. The device of claim 1 wherein the first mode is a pointing mode and the second mode is a scroll mode.

7. The device of claim 6 further comprising a device driver to receive signals from a controller to enable the scroll mode.

8. The device of claim 1 wherein the pointing device is a pointing stick.

9. A method to change the operation of a pointing device comprising:
maintaining a pointing device in a first mode;
receiving a change mode signal from a button for generation primary actions; and
changing operation of the pointing device from the pointing mode to an alternative mode in response to receiving the change mode signal.

10. The method of claim 9 further comprising moving data in a window if the pointing device is in the second mode.

11. The method of claim 9 further comprising performing a click for the primary action.

12. The method of claim 9 further comprising enabling the change mode signal by activating the button for a time longer than a programmed time.

13. The method of claim 9 further comprising activating the button and activating a second button to enable the change mode signal.

14. The method of claim 9 further comprising enabling a change mode signal for changing a pointing device to a first mode if in a second mode.

15. The method of claim 14 further comprising displaying an indication of the pointing mode.

16. The method of claim 9 wherein the second mode is a scroll mode.

17. A computer readable medium comprising instructions that if executed cause a processor to:
move a pointer on a display if a pointing device is in a pointing mode; and
change the pointing device from a first mode to a second mode if a signal is received from a pointing device button to change the pointing device to the second mode.

18. The computer readable medium of claim 17 further comprising instructions that if executed on a computer cause data to move in a horizontal direction if the alternative mode is enabled and a pointing device is moved.

19. The computer readable medium of claim 17 further comprising instructions that if executed on a computer cause the pointing device to change to a scroll mode if a signal is received from a pointing device button to change the pointing device from a pointing mode

20. The computer readable medium of claim 18 further comprising instructions that if executed on a computer cause the computer to automatically return to pointing mode if in a scroll mode after the pointing device is inactive for a time.
